(19) United States
(12) Patent Application Publication
(10) Pub. No.: US 2018/0156385 A1
(43) Pub. Date: Jun. 7, 2018

(54) SAFETY DEVICE TO LIMIT KICKBACK ON HANDHELD POWER TOOLS

(71) Applicants: SAINT-GOBAIN ABRASIVES, INC., Worcester, MA (US); SAINT-GOBAIN ABRASIFS, Conflans-Sainte-Honorine (FR)

(72) Inventors: Igor Giglio, Strassen (LU); Eric Jankowski, Doncourt (FR)

(21) Appl. No.: 15/827,009

(22) Filed: Nov. 30, 2017

Related U.S. Application Data
(60) Provisional application No. 62/430,714, filed on Dec. 6, 2016.

(51) Int. Cl. F16P 1/00; B23D 59/00; B25F 5/02

(52) U.S. Cl. CPC F16P 1/00; B25F 5/02; B23D 59/00

(57) ABSTRACT

A safety device for use with a hand-held power tool. The safety device can include a tether assembly including a first end and a second end opposite the first end, the first end can attach to a hand-held power tool, such as on a handle of the hand-held power tool. The second end can engage an operator, and can include a stirrup to engage a foot of an operator. A reactive device can be disposed at or between the first and second ends, and can have one or more mechanisms to arrest upward movement of the tool in response to a kickback motion of the tool during operation.

### CROSS-REFERENCE TO RELATED APPLICATION

This Application claims priority under 35 U.S.C. § 119(e) to U.S. Provisional Patent Application No. 62/430,714, entitled “SAFETY DEVICE TO LIMIT KICKBACK ON HANDHELD POWER TOOLS,” by Igor Giglio et al., filed Dec. 6, 2016, which is assigned to the current assignee hereof and is incorporated herein by reference in its entirety.

### FIELD OF THE DISCLOSURE

The present invention relates to a safety device to limit kickback motion on handheld power tools such as high-speed saws.

### DESCRIPTION OF THE RELATED ART

Tools used for infrastructure improvement and repair, such as building or repairing roads and buildings, are vital to the continued economic expansion of developing regions. Tools such as chainsaws and high-speed saws are examples of handheld power tools that have been found vital in the construction industry to this end. However, operation of such power tools can pose certain risk of injury to an operator. For example, a sudden and uncontrolled motion of the power tool during operation is known in the industry as “kickback” and can result as the often high-speed rotation of the cutting or grinding device of the power tool comes into contact with a workpiece. Typically, kickback can be a sudden upward motion in a direction toward the operator of the power tool. Contact of the power tool with the operator resulting from the sudden force of kickback can cause serious injury or even death to the operator. Accordingly, improvements are needed in the construction industry to limit or prevent injuries caused by kickback of handheld power tools.

### BRIEF DESCRIPTION OF THE DRAWINGS

The present disclosure may be better understood, and its numerous features and advantages made apparent to those skilled in the art, by referencing the accompanying drawings.

FIG. 1 includes a perspective view of a safety device for use with a handheld power tool in accordance with an embodiment.

FIG. 2 includes a left-hand planar view of an operator employing an embodiment of the safety device with a handheld power tool.

FIG. 3 includes a right-hand planar view of the embodiment of FIG. 2.

The use of the same reference symbols in different drawings indicates similar or identical embodiments.

### DETAILED DESCRIPTION

In general, embodiments of the safety device herein can include a tether assembly having a first end and a second end opposite the first end. The first end can be configured to attach to a handheld power tool, and the second end can be configured to engage a lower extremity of an operator, such as a knee or a foot. More particularly, the safety device can include a reactive device disposed at the first end or the second end, or between the first end and the second end of the tether assembly. The reactive device can be configured to arrest upward movement of the handheld power tool in response to a change in velocity of the power tool in excess of a predetermined rate.

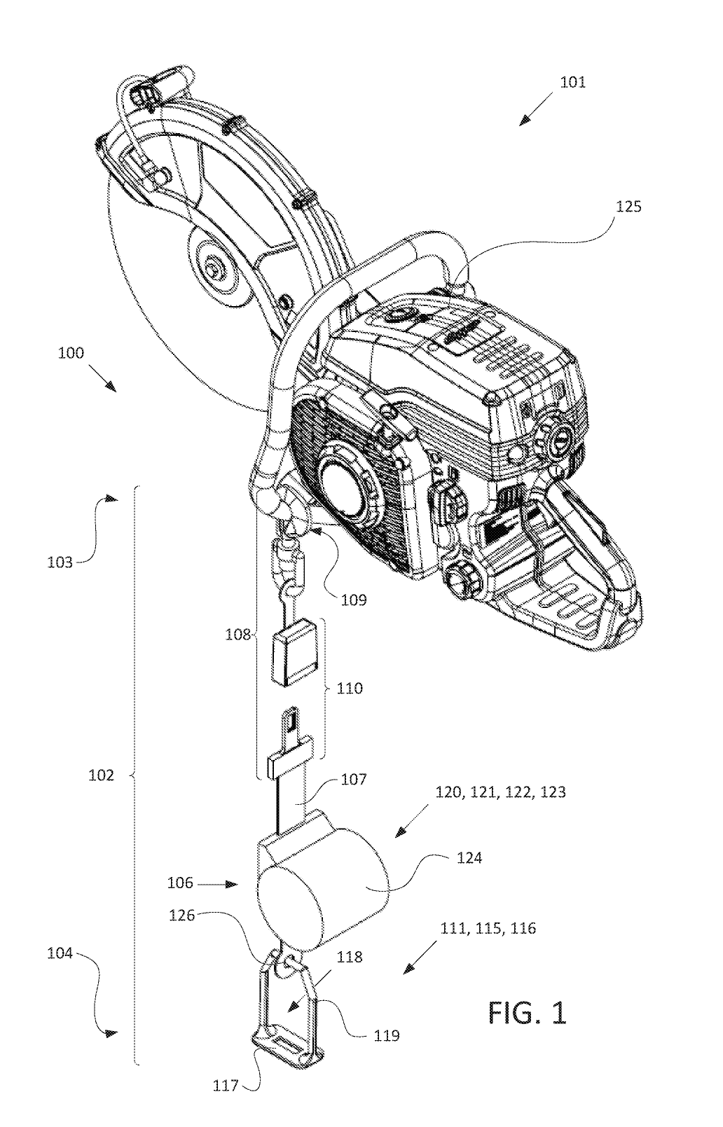

FIG. 1 includes a perspective view of a safety device 100 for use with a handheld power tool 101 in accordance with an embodiment. As illustrated, the safety device 100 can include a tether assembly 102. The tether assembly 102 can have a first end 103 and a second end 104 that is opposite to the first end 103.

The first end 103 of the tether assembly 102 can be configured to attach to a handheld power tool 101. In an embodiment, the first end 103 can include a first attachment member 109 for attaching to the handheld power tool 101. In an embodiment, the first attachment member 109 can include a hook, clip, threadably engagable member, pin, snap, securable strap, quick release buckle, or any combination thereof. In a particular embodiment, the first attachment member 109 includes a hook. The hook can include an open hook, a carabiner hook, a snap hook, or a combination thereof. The first attachment member 109 (e.g., hook) can attach to any portion of the handheld power tool 101, such as to a handle or chassis portion of the power tool 101.

In another embodiment, the first end 103 can be an integral part of the power tool 101. For example, the first end 103 can be an integral portion of a handle or chassis of the power tool 101. In an embodiment, the first end 103 can be integrally molded to a portion of the power tool, such as the handle or chassis, for example. In a particular embodiment, the first end can include the reactive device 106, such that a housing 124 of the reactive device 106 can be integrally formed with the power tool 101.

Referring back to FIG. 1, the first end 103 can include a tether member 107 extending from the reactive device 106 and having a distal end 108 configured to attach to the handheld power tool 101. In an embodiment, the distal end 108 of the tether member 107 can include a first attachment member 109 for attaching to the handheld power tool 101. In an embodiment, the first attachment member 109 can include a hook, clip, threadably engagable member, pin, snap, securable strap, quick release buckle, or any combination thereof. In a particular embodiment, the first attachment member 109 of the distal end 108 includes a hook. The hook can include an open hook, a carabiner hook, a snap hook, or a combination thereof. The first attachment member 109 (e.g., hook) can attach to any portion of the handheld power tool 101, such as to a handle or chassis of the power tool 101.

In an embodiment, the distal end 108 of the tether member 107 can include a second attachment member 110 for engaging the first attachment member 109. In an embodiment, the second attachment member 110 can include a hook, clip, threadably engagable member, pin, snap, securable strap, a quick release buckle, or any combination thereof. In a particular embodiment, the second attachment member 110 includes a quick release buckle.

In an embodiment, the tether member 107 can have an adjustable length. For example, the tether member 107, or at least a portion thereof, can be wound around a shaft or reel (not shown) within the enclosure 124 of the reactive device 106 such that the length of the tether member 107 extending from the reactive device 106 is shortened. Alternatively, the tether member 107, or at least a portion thereof, can be unwound around the shaft or reel within the enclosure 124 of the reactive device 106 such that the length of the tether member 107 extending from the reactive device 106 is lengthened. It will be appreciated that the shaft or reel around which a portion of the tether member 107 can be wound or unwound can be included in the reactive device 106 according to commonly available reactive devices known in the art, as discussed further herein.

According to an embodiment, the length of the tether member 107 can be selectably fixed. That is, the length can be adjusted to a desirable length and fixed at that length such that the length will not change during use. According to another embodiment, the length of the tether member 107 can be automatically adjustable, such that the length can change during use. It will also be appreciated that an adjustable length of the tether is important for maneuvering the power tool around or over a workpiece, such as a large concrete pipe. In addition, as the workpiece is processed by the power tool 101, the distance from the power tool to the operator's foot, for example, may change. Accordingly, it may be desirable for the length of the tether member 107 to be automatically adjustable during use and without further operator input. According to an embodiment, the tether member 107 can be attached to a retracting mechanism configured to automatically shorten or lengthen the length of the tether member 107. The retracting mechanism can be included in the reactive device 106, as discussed further herein.

The tether member 107 can be fabricated from one or more materials. In accordance with an embodiment, the tether member 107 can include a natural material, a synthetic material, or a combination thereof. In more particular embodiments, the material of the tether member 107 can include leather, cotton, rubber, metal, rubber, plastic, nylon, or a combination thereof. The tether member 107 can include a certain construction. In accordance with an embodiment, the construction of the tether member 107 can be extruded, laminated, woven, a fabric, a rope, a cable, or any combination thereof.

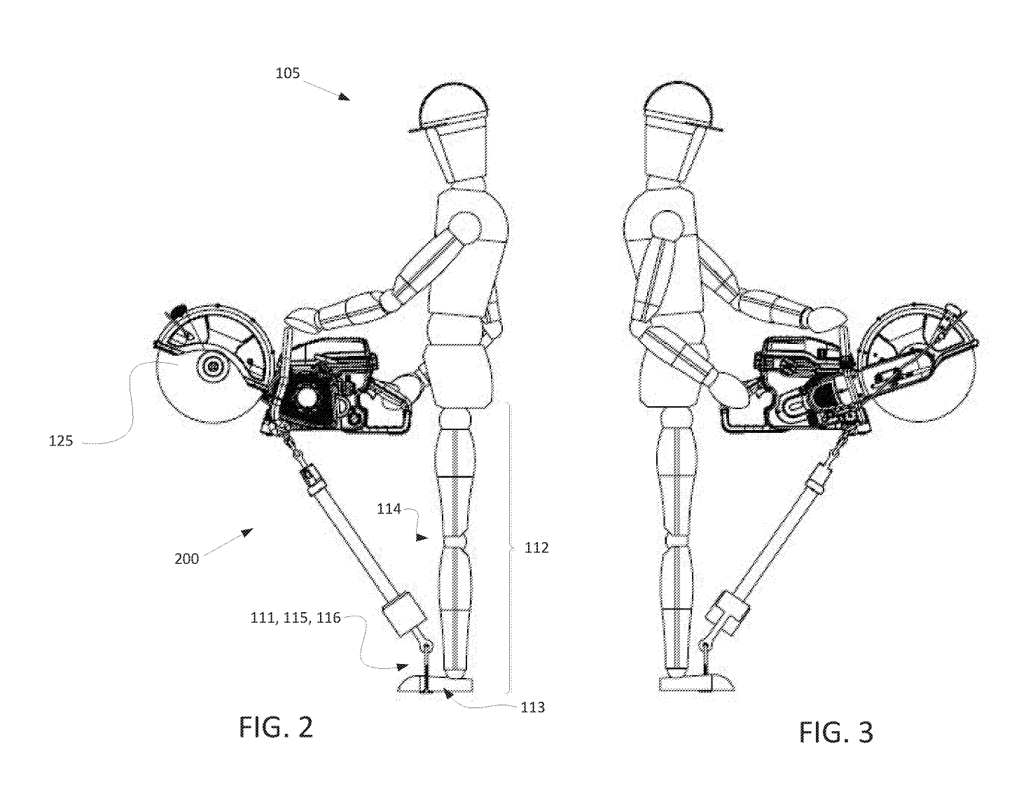

As noted above, the tether assembly 102 can include a second end 104 configured to engage an operator. In accordance with an embodiment, the second end 104 can include an engagement member 111 configured to engage a lower extremity of an operator, such as a foot, an ankle, or a knee. FIG. 2 includes a left-hand planar view of an operator 105 employing an embodiment of the safety device 200 with a handheld power tool 101. FIG. 3 includes a right-hand planar view of the embodiment of FIG. 2. As illustrated in FIGS. 2 and 3, the safety device 200 can be configured to attach to a lower extremity 112 of an operator 105 and a handheld power tool, such as a high speed saw 125. In an embodiment, the engagement member 111 can include a foot engagement member 115. The foot engagement member can include a harness that attaches to an operator's foot 113. In a particular embodiment as generally illustrated in FIG. 2, the foot engagement member 115 can include a stirrup 116 for engaging a foot 113 of an operator 105. It will be appreciated that the engagement member 111 can alternatively include a knee engagement member for engaging a knee 114 of the lower extremity 112 of an operator 105.

Referring back to FIG. 1, the engagement member 111 of the second end 104 can include a foot engagement member 115. In an embodiment, the foot engagement member 115 can include a stirrup 116. In a particular embodiment, the stirrup can include a foothold base structure 117 and an aperture 118 through which a foot of an operator can be engagably inserted. The aperture 118 of the stirrup 116 can be defined by a perimeter 119 configured to encircle a foot of an operator.

In an embodiment, the second end 104 of the tether assembly 102 can be attached to the reactive device 106. The second end 104 can further include a harness that attaches to an operator's foot, ankle or knee, the harness in turn attaching to the reactive device 106. In a particular embodiment as generally illustrated in FIG. 1, the second end 104 can be attached to the reactive device by a portion of a stirrup 116. In particular, the stirrup 116 can include the perimeter 119 that can be attached to an eyelet member 126 of the reactive device 106.

In accordance with an embodiment, the tether assembly 102 can include a reactive device 106 disposed between the first end 103 and the second end 104 of the tether assembly 102, as generally illustrated in FIG. 1. In this embodiment, the reactive device 106 can be disposed along a distance between two attachment members, in which a first attachment member can attach to the power tool 101 (i.e., a tool attachment member), and a second attachment member can attach to an operator (i.e., an operator attachment member). In another embodiment, the reactive device 106 can be disposed at either the first end 103 or the second end 104, in which the reactive device 106 is at a distal position along the tether assembly 102 from an attachment member configured to be attached to either the power tool 101 or the operator 105. For example, the reactive device 106 may be formed integrally with the power tool 101. In another example, the reactive device 106 may be formed integrally with a lower extremity engagement member such as a stirrup, foot harness, ankle harness, or knee harness.

In accordance with an embodiment, the reactive device 106 can include an enclosure 124 housing a portion of the tether member 107, and one or more of a locking mechanism 120, a retracting mechanism 122, or any combination thereof.

In accordance with an embodiment, the reactive device 106 can include a locking mechanism 120. The reactive device 106 can include the tether member 107 coupled to the locking mechanism 120. For example, the locking mechanism 120 can include a reel or shaft, or coupled to the reel or shaft, about which the tether member 107 can be attached and wound according to any conventional means.

The locking mechanism 120 and/or the reel or shaft can form part of an assembly including a centrifugal clutch. In a particular embodiment, the locking mechanism 120 can be configured to prevent movement of the tether member 107 relative to the locking mechanism 120 in response to an acceleration of the tether member 107 with respect to the locking mechanism 120 in excess of a predetermined value.

In accordance with an embodiment, the reactive device 106 can include a retracting mechanism 122 configured to retract the tether member 107 toward the retracting mechanism 122. The retracting mechanism 122 can form part of an assembly including a centrifugal clutch. In a particular embodiment, the retracting mechanism 122 can include a tensioner, self-coiling spring 123, or a combination thereof.

In accordance with an embodiment, a centrifugal clutch assembly can include the locking mechanism 120, retracting mechanism 122.

In an embodiment, the reactive device 106 can include an inertial mechanism such as an inertia-locking retractor. As known in the art, an inertia-locking retractors can lock when a locking mechanism such as an internal centrifugal clutch that senses a strong or sudden tug. For example, the strong or sudden tug can be defined as a change in velocity in excess of a predetermined rate of an internal reel of the reactive device 106 around which the tether member 107 can be wound or unwound. As the tether member 107 is attached to the power tool 101, a change in velocity of the power tool in excess of a predetermined rate (e.g., a strong or sudden tug caused by kickback) can cause the internal reel to spin rapidly and engage the centrifugal clutch, which in turn can stop the tether member 107 from being released, or otherwise prevent the tether assembly 102 from further elongation. As is also known in the art, commonly available inertial mechanisms are configured not to lock under normal operating circumstances, such as lengthening or shortening the tether member 107 gently or below a predetermined velocity threshold in accordance with embodiments herein.

Example of Method of Use According to an Embodiment

The following example demonstrates a method of use of an embodiment. A high speed saw 125 is used in this example to represent handheld power tools 101 capable of exhibiting a kickback motion, however this example is by no means restricted to a high speed saw 125, and can be applied to other tools in this category of tool.

An operator 105 of a high-speed saw 125 may first attach the first end 103 of the tether assembly to the high-speed saw 125, typically to a bottom portion or segment of the front handle, by using the first attachment disclosed above in accordance with an embodiment such as a hook. The operator 105 may then attach the tether member 107 to the quick-release buckle 110 (if equipped) and adjust the length of the tether member 107 by inserting one foot 113 into the foot engagement member 115, which preferably comprises a stirrup 116 or footplate, and pressing the foot engagement member 115 firmly to the ground using his or her body weight.

The tether is then adjusted to a suitable length such that the anchored tether is taught when the operator 105 holds the high speed saw 125 at a comfortable and safe height with respect to the anchoring foot. Preferably, the height of the high-speed saw 125 is chosen according to best practices of operating the handheld power tool, such as the high-speed saw 125, and with respect to the type of work to be performed. The operator 105 may then engage in the work to be performed, such as cutting concrete, using the tethered high speed saw 125. If kickback occurs, the invention constrains the high-speed saw 125 from moving vertically towards the operator's upper body in an uncontrolled manner, limiting the degree of kickback that could pose serious injury to the operator.

### EMBODIMENTS

### Embodiment 1

A safety device for use with a hand-held power tool, comprising:

a tether assembly including a first end and a second end opposite the first end, the first end configured to attach to a hand-held power tool, and the second end configured to engage an operator; and
a reactive device between the first end and the second end, the reactive device configured to arrest upward movement of the tool in response to change in velocity in excess of a predetermined rate.

### Embodiment 2

The safety device of embodiment 1, wherein the tether assembly includes a tether member extending from the reactive device and having a distal end configured to attach to the hand-held power tool.

### Embodiment 3

The safety device of embodiment 2, wherein the distal end comprises a hook.

### Embodiment 4

The safety device of embodiment 3, wherein the hook comprises an open hook, a carabiner hook, snap hook, or a combination thereof.

### Embodiment 5

The safety device of embodiment 2, wherein the distal end comprises a quick-release buckle.

### Embodiment 6

The safety device of any one of the above embodiments, wherein the second end comprises an engagement member attached to the reactive device.

### Embodiment 7

The safety device of embodiment 6, wherein the engagement member is configured to engage a lower extremity of an operator.

### Embodiment 8

The safety device of embodiment 7, wherein the engagement member is configured to engage a foot or a knee of the operator.

### Embodiment 9

The safety device of embodiment 7, wherein the engagement member comprises a foot engagement member.

### Embodiment 10

The safety device of embodiment 9, wherein the foot engagement member comprises a foothold base structure and an aperture, said aperture having a perimeter configured to encircle a foot of the operator.

### Embodiment 11

The safety device of embodiment 9, wherein the foot engagement member comprises a stirrup.

### Embodiment 12

The safety device of embodiment 8, wherein the engagement member comprises a knee engagement member.

### Embodiment 13

The safety device of embodiment 1, wherein the reactive device comprises a tether member coupled to a locking mechanism, wherein the locking mechanism is configured to prevent movement of the tether member relative to the locking mechanism in response to an acceleration of the tether member with respect to the locking mechanism in excess of a predetermined value.

### Embodiment 14

The safety device of embodiment 1, wherein the reactive device comprises a retracting mechanism configured to retract the tether member toward the retracting mechanism.

### Embodiment 15

The safety device of embodiment 14, wherein the retracting mechanism comprises a self-coiling spring.

### Embodiment 16

The safety device of embodiment 1, wherein the reactive device comprises an enclosure housing a portion of the tether member, and one or more of a locking mechanism, a retracting mechanism, or a combination thereof.

### Embodiment 17

The safety device of embodiment 1, wherein the hand-held power tool is a high speed saw.

### Embodiment 18

A safety device for use with a hand-held power tool, comprising:

a tether assembly including a first end and a second end opposite the first end, the first end configured to attach to a hand-held power tool, and the second end configured to engage an operator; and
a reactive device disposed at the first end, the reactive device configured to arrest upward movement of the tool in response to change in velocity in excess of a predetermined rate.

### Embodiment 19

The safety device of embodiment 18, wherein the reactive device is integrally formed with the hand-held power tool.

### Embodiment 20

A safety device for use with a hand-held power tool, comprising:

a tether assembly including a first end and a second end opposite the first end, the first end configured to attach to a hand-held power tool, and the second end configured to engage an operator; and
a reactive device disposed at the second end, the reactive device configured to arrest upward movement of the tool in response to change in velocity in excess of a predetermined rate.

### Embodiment 21

The safety device of embodiment 20, wherein the reactive device is integrally formed with a foot or ankle harness.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

What is claimed is:

1. A safety device for use with a hand-held power tool, comprising:
a tether assembly including a first end and a second end opposite the first end, the first end configured to attach to a hand-held power tool, and the second end configured to engage an operator; and
a reactive device between the first end and the second end, the reactive device configured to arrest upward movement of the tool in response to change in velocity in excess of a predetermined rate.

2. The safety device of claim 1, wherein the tether assembly includes a tether member extending from the reactive device and having a distal end configured to attach to the hand-held power tool.

3. The safety device of claim 2, wherein the distal end comprises a hook.

4. The safety device of claim 3, wherein the hook comprises an open hook, a carabiner hook, snap hook, or a combination thereof.

5. The safety device of claim 2, wherein the distal end comprises a quick-release buckle.

6. The safety device of claim 1, wherein the second end comprises an engagement member attached to the reactive device.

7. The safety device of claim 6, wherein the engagement member is configured to engage a lower extremity of an operator.

8. The safety device of claim 7, wherein the engagement member is configured to engage a foot or a knee of the operator.

9. The safety device of claim 7, wherein the engagement member comprises a foot engagement member.

10. The safety device of claim 9, wherein the foot engagement member comprises a foothold base structure and an aperture, said aperture having a perimeter configured to encircle a foot of the operator.

11. The safety device of claim 9, wherein the foot engagement member comprises a stirrup.

12. The safety device of claim 8, wherein the engagement member comprises a knee engagement member.

13. The safety device of claim 1, wherein the reactive device comprises a tether member coupled to a locking mechanism, wherein the locking mechanism is configured to prevent movement of the tether member relative to the locking mechanism in response to an acceleration of the tether member with respect to the locking mechanism in excess of a predetermined value.

14. The safety device of claim 1, wherein the reactive device comprises a retracting mechanism configured to retract the tether member toward the retracting mechanism.

15. The safety device of claim 14, wherein the retracting mechanism comprises a self-coiling spring.

16. The safety device of claim 1, wherein the reactive device comprises an enclosure housing a portion of the tether member, and one or more of a locking mechanism, a braking mechanism, a retracting mechanism, or a combination thereof.

17. A safety device for use with a hand-held power tool, comprising:
a tether assembly including a first end and a second end opposite the first end, the first end configured to attach to a hand-held power tool, and the second end configured to engage an operator; and
a reactive device disposed at the first end, the reactive device configured to arrest upward movement of the tool in response to change in velocity in excess of a predetermined rate.

18. The safety device of claim 17, wherein the reactive device is integrally formed with the hand-held power tool.

19. A safety device for use with a hand-held power tool, comprising:
a tether assembly including a first end and a second end opposite the first end, the first end configured to attach to a hand-held power tool, and the second end configured to engage an operator; and
a reactive device disposed at the second end, the reactive device configured to arrest upward movement of the tool in response to change in velocity in excess of a predetermined rate.

20. The safety device of claim 19, wherein the reactive device is integrally formed with a foot or ankle harness.
